(19) United States
(12) Patent Application Publication
(10) Pub. No.: US 2003/0019998 A1
(43) Pub. Date: Jan. 30, 2003

(54) Base for mounting flagpole

(76) Inventor: Hsien-Jung Kou, Changhua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/974,831

(22) Filed: Oct. 12, 2001

(30) Foreign Application Priority Data
Jul. 24, 2001 (TW) 90212546

(51) Int. Cl. A01K 97/10; H01Q 1/12; A47G 25/12; A45B 25/28; A47G 33/12

(52) U.S. Cl. 248/534; 248/511

(57) ABSTRACT

A base for the mounting of a flagpole is disclosed in this invention, the base comprises a base body for fastening to a vehicle and a barrel upwardly extended from the base body and adapted to hold the flagpole. The base body has a hook portion obliquely upwardly extended from one side thereof and a retaining portion downwardly extended from an opposite side thereof, the retaining portion having a semicircular bottom notch.

### FIELD OF THE INVENTION

The present invention relates generally to advertising apparatus and, more specifically, to a base adapted to mount a flagpole therein, which can be easily positively fastened to a car, motorcycle, or bicycle to hold a flag and can be detached from the foregoing vehicle easily.

### BACKGROUND OF THE INVENTION

FIG. 1 illustrates a flag-anchoring device 1 according to the prior art. This structure of flag anchoring device 1 comprises a hooked base body 2 for hooking on an object, and a post 3 of crossed section vertically extended from the base body 2 for holding a flag 5. The post 3 has two hooked portions 4 adapted to secure the bottom side of the flag 5. When in use, the hooked base body 2 is hooked on the top side edge of the window glass. When the window glass lifted, the hooked base body 2 is secured in place. However, the flag-anchoring device 1 tends to be forced out of position when the flag 5 receives a strong wind. This design of flag anchoring device is designed to hold a flag without flagpole, not for a flag having a fixed flagpole. Further, this design of flag anchoring device is designed for use in a car or truck, but not suitable for mounting in a motorcycle or bicycle.

### SUMMARY OF THE INVENTION

The present invention has been accomplished to provide a base for the mounting of a flagpole, which eliminates the aforesaid drawbacks.

It is the primary object of the present invention to provide a base adapted to mount a flagpole therein, which can firmly be fastened to a vehicle to hold a flag positively.

It is another object of the present invention to provide a base adapted to mount a flagpole therein, which can easily positively be fastened to a car, a motorcycle, a bicycle, or any of a variety of vehicles to hold a flag.

It is still another object of the present invention to provide a base, which is practical for holding a flagpole with a fixed flag.

To achieve these objects of the present invention, a base adapted to mount a flagpole therein comprises a base body for fastening to a vehicle, and a barrel upwardly extended from the base body and adapted to hold the flagpole. The base body comprises a hook portion obliquely upwardly extended from one side thereof and a retaining portion downwardly extended from an opposite side thereof, the retaining portion having a semicircular bottom notch. The barrel comprises a flexible cord member suspended from the periphery of the top side thereof, the flexible cord member having a fixed end suspended from the periphery of the top side of the barrel and a plurality of beads at the free end thereof, and an outside lug fixedly provided at the periphery thereof, the outside lug having a retaining notch adapted to secure the free end of the flexible cord member in place.

### BRIEF DESCRIPTION OF THE DRAWINGS

FIG. 1 illustrates a flag-anchoring device according to the prior art.

FIG. 2 is a perspective view showing a base installed in the window glass of a vehicle according to a preferred embodiment of the present invention.

FIG. 3 is a front view of the base according to the preferred embodiment of the present invention.

FIG. 4 is a side view of the base according to the preferred embodiment of the present invention.

FIG. 5 shows one application example of the present invention.

FIG. 6 shows an end cap of the base according to the preferred embodiment of the present invention.

FIG. 7 shows another application example of the present invention.

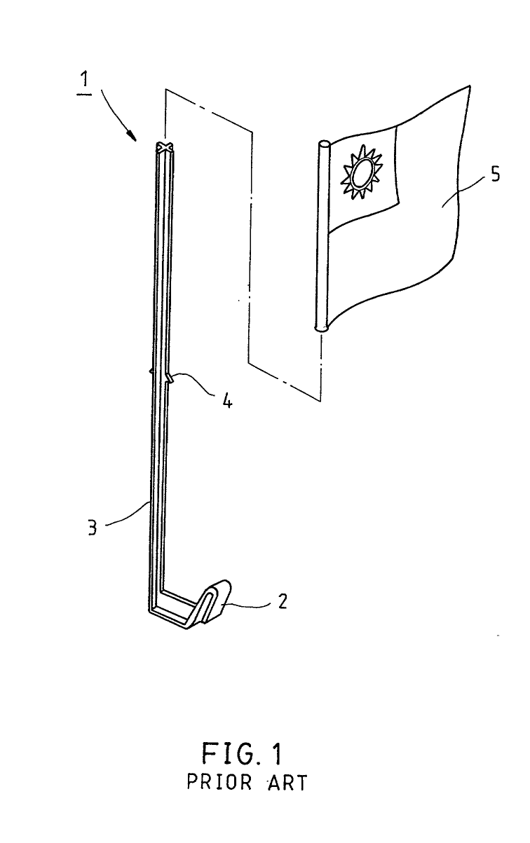

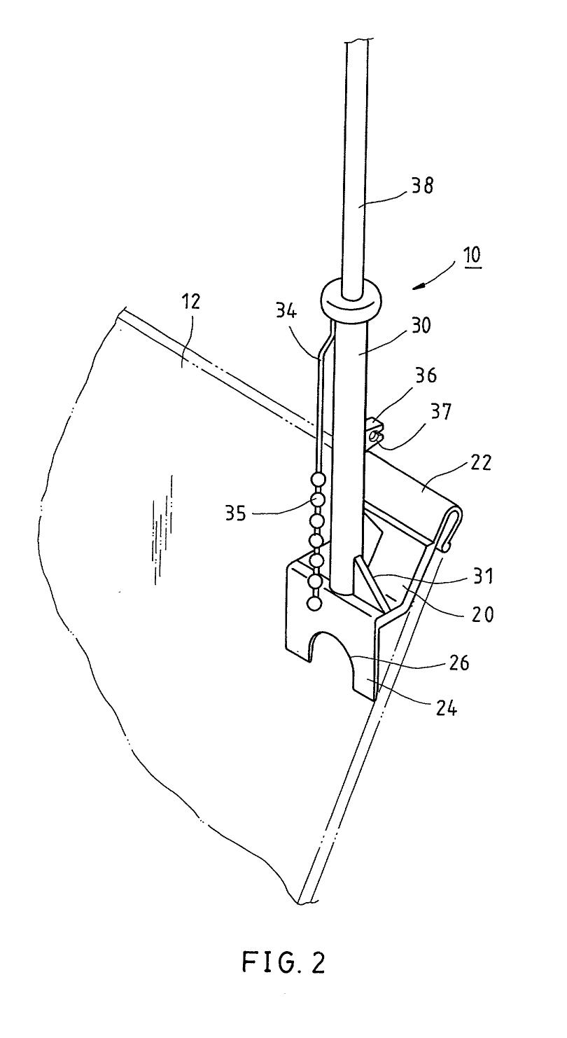

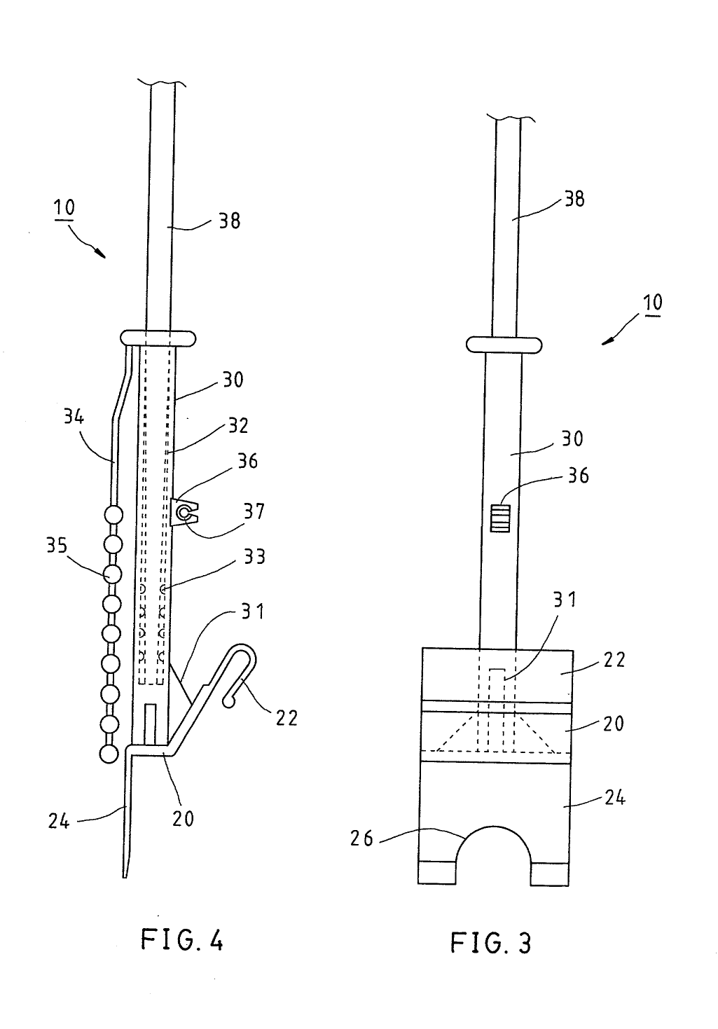

### DETAILED DESCRIPTION OF THE INVENTION

Referring to FIGS. from 2 through 4, a base 10 for the mounting of a flagpole 38 is shown comprised of a base body 20, and an upright barrel 30. By means of the base body 20, the base 10 can be fastened to the top side edge of a vehicle window glass 12.

The base body 20 comprises a hook portion 22 obliquely upwardly extended from one side thereof for hooking on the top side edge of the vehicle window glass 12, and a retaining portion 24 downwardly extended from the opposite side thereof for stopping at one side of the vehicle window glass 12. The retaining portion 24 has a semicircular bottom notch 26.

The barrel 30 is fixedly connected to and upwardly extended from the top sidewall of the base body 20. Three reinforcing ribs 31 are fixedly connected between the peripheral wall of the barrel 30 and the top sidewall of the base body 20. The barrel 30 has an axial hole 32 adapted to hold the flagpole 38. The axial hole 32 has a diameter gradually reduced from the top end (the end remote from the base body 20) of the barrel 30 toward the bottom end (the end connected to the base body 20) of the barrel 30. Friction rings 33 are fixedly provided inside the axial hole 32 at different elevations. When inserting the flagpole 38 into the axial hole 32 of the barrel 30, a friction resistance is produced between the friction rings 33 and the periphery of the flagpole 38, keeping the flagpole 38 positively secured to the inside of the barrel 30. Further, an elastic cord member 34 is suspended from the periphery of the flanged top end of the barrel 30. A plurality of beads 35 are fixedly fastened to the elastic cord member 34 and equally spaced from one another. The barrel 30 further comprises a lug 36 at one side. The lug 36 has a locating notch 37 adapted to receive one of the beads so as to secure the free end of the elastic cord member 34 in place.

When the vehicle window glass 12 lifted after installation of the base 10 in the window glass 12, the hook 22 is positively stopped between the top side edge of the window glass 12 and the window frame of the vehicle, and the retaining portion 24 is supported on one side of the vehicle window glass 12 to support the base 10 positively in position. Before installation of the flagpole 38, the advertising or election campaign flag is fastened to the flagpole 38.

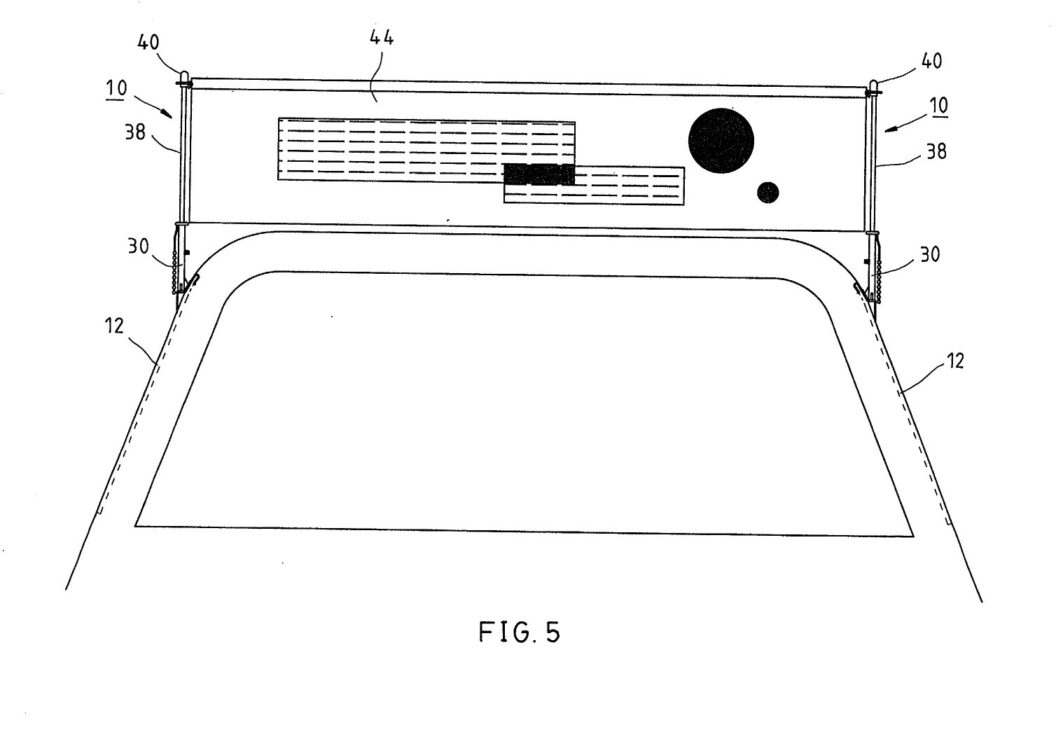

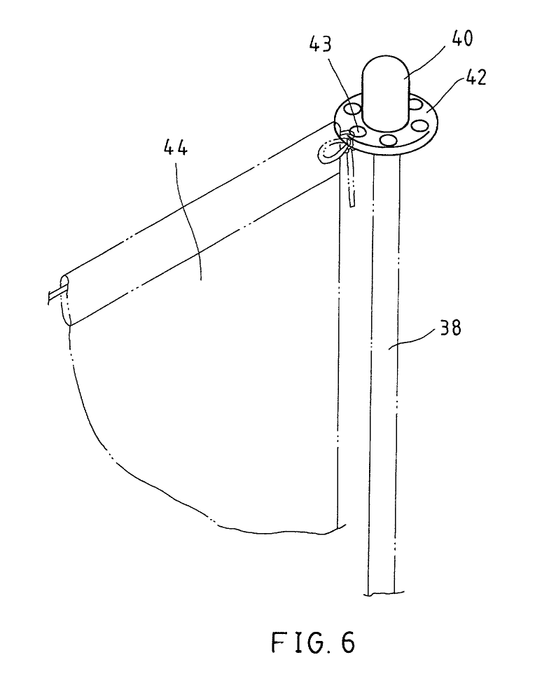

FIGS. 5 and 6 show one application example of the present invention. As illustrated, two base 10 are installed in the window glasses 12 of two opposite windows of the car to hold two flagpoles 38 and a flag 44 between the flagpoles 38.

Each base 10 is further comprised of an end cap 40, which is fastened to the top end of the flagpole 38. The end cap 40 has a hook portion 42, which is provided with a plurality of through holes 43 for the fastening of the flag 44.

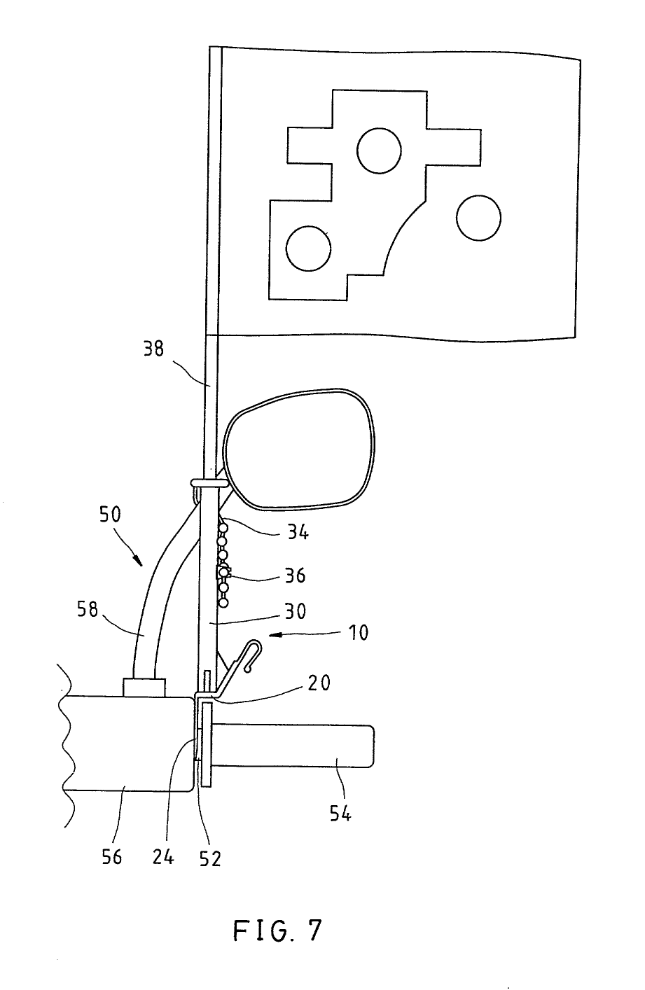

Referring to FIG. 7, the base 10 can be fastened to the head of a motorcycle 50. The motorcycle 50 comprises a head frame 52, a handgrip 54 at each side of the head frame 52, an instrument case 56 supported on the head frame 52, and a bracket for rear-view mirror 58. The retaining portion 24 of the base body 20 is inserted through the gap between the handgrip 54 and the instrument case 56 to force the semicircular bottom notch 26 into engagement with the head frame 52, for enabling the barrel 30 to be peripherally supported on the bracket for rear-view mirror 58, and then the elastic cord member 34 is wound round the bracket for rear-view mirror 58 and fastened to the lug 36 to secure the barrel 30 to the bracket for rear-view mirror 58 positively. In the same manner, the base 10 can be fastened to a bicycle.

The base 10 can be injection-molded from plastics, for example, polypropylene resin for the advantages of low cost and easy fabrication. The elastic cord member 34 and the lug 36 may be eliminated subject to different requirements. A rope or the like may be used to fasten the barrel 30 to the bracket for rear-view mirror 58.

What is claimed is:

1. A base adapted to mount a flagpole therein, said base comprising:
a base body provided with a hook portion obliquely upwardly extended from one side thereof and a retaining portion downwardly extended from an opposite side of said hook portion, said retaining portion having a notch;
a barrel upwardly fixedly extended from said base body, said upright barrel having an axial hole for the holding of said flagpole.

2. The base as claimed in claim 1 wherein said barrel further comprises a flexible cord member and an outside lug, said flexible cord member having a fixed end fastened to the periphery of a top side of said barrel and a plurality of beads disposed at a free end thereof, said outside lug having a retaining notch adapted to secure the free end of said flexible cord member in place.

3. The base as claimed in claim 2 wherein said base body and said barrel are injection-molded from polypropylene resin in integrity.

4. The base as claimed in claim 1 wherein said base body and said barrel are injection-molded from polypropylene resin in integrity.

5. The base as claimed in claim 1 wherein said axial hole of said barrel has a diameter gradually reduced in direction toward said base body.

6. The base as claimed in claim 1 wherein said barrel has a plurality of friction rings disposed inside said axial hole at different elevations and adapted to secure said flagpole in said axial hole.

7. The base as claimed in claim 1 further comprising a plurality of reinforcing ribs connected between the periphery of said barrel and said base body.

8. The base as claimed in claim 1 further comprising an end cap fastened to a top end of said flagpole, said end cap having a hook portion which is provided with a plurality of through holes for the fastening of a flag.
